(19) United States
(12) Patent Application Publication
(10) Pub. No.: US 2024/0343898 A1
(43) Pub. Date: Oct. 17, 2024

(54) CORE SHELL FLUOROPOLYMERS WITH FUNCTIONAL GROUPS SUITABLE FOR COPPER AND ELECTRONIC TELECOMMUNICATIONS ARTICLES

(71) Applicant: 3M INNOVATIVE PROPERTIES COMPANY, St. Paul, MN (US)

(72) Inventors: Michael C. Dadalas, Burghausen (DE); Klaus Hintzer, Kastl (DE); Naiyong Jing, St. Paul, MN (US); Steffen Vowinkel, Mühldorf am Inn (DE)

(21) Appl. No.: 18/579,647

(22) PCT Filed: Aug. 12, 2022
(86) PCT No.: PCT/IB2022/057567

§ 371 Date: Jan. 16, 2024

Related U.S. Application Data
(60) Provisional application No. 63/244,919, filed on Sep. 16, 2021.

(51) Int. Cl. C08L 27/18

(52) U.S. Cl. CPC C08L 27/18; C08L 2203/20; C08L 2207/53

(57) ABSTRACT

Presently described are electronic telecommunication articles comprising core shell fluoropolymers comprising polymerized units of tetrafluoroethylene and no greater than 1 wt. % of polymerized units of comonomer comprising a functional group. The functional groups are typically selected from nitrile, halogen, sulfur oxide, perfluorinated alkyl ether, and carbonyl. The core shell fluoropolymer typically comprises at least 80, 85, 90, 95, 96, 97, 98, 99 wt. % or greater of polymerized units of tetrafluoroethylene. In some embodiments, the core shell fluoropolymer further comprises up to 20 or 25 wt. % of polymerized units of other comonomers, such as hexafluoropropylene (HFP). Also described are methods of making a coated substrate, coated substrates, and core shell fluoropolymers.

### SUMMARY

Presently described are electronic telecommunication articles comprising core shell fluoropolymers comprising polymerized units of tetrafluoroethylene and no greater than 1 wt. % of polymerized units of comonomer comprising a functional group. The functional groups are typically selected from nitrile, halogen, sulfur oxide, perfluorinated alkyl ether, and carbonyl.

The core shell fluoropolymer typically comprises at least 80, 85, 90, 95, 96, 97, 98, 99 wt. % or greater of polymerized units of tetrafluoroethylene. In some embodiments, the core shell fluoropolymer further comprises up to 20 or 25 wt. % of polymerized units of other comonomers, such as hexafluoropropylene (HFP).

In typical embodiments, the shell has a higher amount of functional groups than the core or higher amount of functional groups than the average amount of functional groups of the core shell fluoropolymer. When the functional groups are concentrated at the exterior of the fluoropolymer, the core shell fluoropolymer can have a higher adhesion to (e.g. copper) metal than a (i.e. non core shell) random fluoropolymer having the same composition. A core shell fluoropolymer can exhibit better electrical properties by minimizing the amount of non-fluorinated functional groups. The functional groups can also provide cure sites for crosslinking.

In some embodiments, the core comprises a copolymer of TFE and at least one perfluorinated comonomer, such as HFP, unsaturated perfluorinated alkyl ether, or a combination thereof. Providing comonomer in the core can improve the melt processability. In some embodiments, the core shell fluoropolymer has a MFI (372 C with 2.16 kg) of less than 50 g/10 min.

Also described are methods of making a coated substrate, coated substrates, and core shell fluoropolymers.

In one embodiment, a core shell fluoropolymer is described that comprises up to 1 wt. % of polymerized units comprising sulfur oxide groups. Representative sulfur oxide groups include for example —SO₂X¹, wherein X¹ is F or NH₂ or —SO₃X², wherein X² is H, Na, Li.

### DETAILED DESCRIPTION

### Core Shell Fluoropolymer

Presently described are electronic telecommunication articles comprising a core shell fluoropolymer. The core shell fluoropolymers are derived from perfluorinated comonomers including tetrafluoroethene (TFE). In some embodiment, the fluoropolymers comprise at least 80, 85, 90, 95, 96, 97, 98, 99 wt. % % by weight of polymerized units derived from TFE.

The core shell fluoropolymer may be characterized as a particle. Typically the core has an average diameter of at least 10, 25, or even 40 nm and no greater than 150, 125, or even 100 nm. The shell may be thick or thin. For example, in one embodiment, the outer shell is a TFE copolymer, having a thickness of at least 100 or 125 nm and no greater than 200 nm. In another embodiment, the outer shell is a TFE copolymer having a thickness of at least 1, 2, 3, 4, 5 nm and no greater than 20 or 15 nm. The shell is typically at least 1, 2, 3, 4, 5, 6, 7, 8, 9, or 10 wt. % of the total core shell fluoropolymer. The shell is typically no greater than 50, 45, 40, 35, 30, 25, 20, 15 or 10 wt. % of the total core shell fluoropolymer. In some embodiments, the thickness of the shell is no greater than 10, 9, 8, 7, 6, or 5 wt. % of the total core shell fluoropolymer.

The core shell fluoropolymers particles can be made using techniques known in the art. In typical embodiments, the core shell fluoropolymers are prepared by aqueous emulsion polymerization with or without fluorinated emulsifiers. The method may further comprise coagulation of the latex, agglomeration and drying. Representative polymerizations are described in WO 2020/132203; incorporated herein by reference.

The core shell fluoropolymer typically comprises a core of one composition (such as TFE homopolymer or TFE copolymer) and a shell of a different composition (for example a shell derived from different monomers or a different concentration of monomers than the core). The core shell fluoropolymer particles may be melt processible or not melt processible. When the core is a TFE homopolymer, the core is not melt processible. In some embodiments, the core further comprises polymerized units of comonomer such as HFP, an unsaturated perfluorinated alkyl ether, or a combination thereof. In some embodiments, the core, the shell, or core shell fluoropolymer may be characterized as melt-processible, having an MFI (melt flow index) at 372° C. and 2.16 kg of load of less than 50, 45, or 40 g/10 min. In some embodiments, the core material, shell material, or core shell fluoropolymer has a MFI at 372° C. and 21.6 kg of less than 5, 4, 3, 2, 1 or 0.5 g/10 min.

In one embodiment, the (e.g. semi crystalline) core shell fluoropolymer has a melting point after a second heating of greater than 320, 325, or 330° C. A solid PTFE polymer can have different phases that can be measured by thermo-mechanical analysis. For example, at around 19° C. and atmospheric pressure, PTFE goes from triclinic crystal II to hexagonal crystal IV, and at around 32° C. and atmospheric pressure, from hexagonal crystal IV to pseudohexagonal crystal I as described in Sperati, C. A., Adv. Polym. Sci., 2: 465, 1961. Such physical changes occur at phase transition temperatures, which can be indicated by peaks when monitoring the heat flow versus temperature for the solid material using DMA (dynamic mechanical analysis). In one embodiment, the semi crystalline fluoropolymer further comprising polymerized units of comonomer has a phase transition temperature of greater than 15, 16, or 17° C. and no greater than 20, 21, or even 22° C.

Core shell fluoropolymer particles having a higher molecular weight fluoropolymer may be characterized as non melt processible, i.e. having a melt flow index of less than 0.1, 0.05, or 0.001 g/10 min at 372° C., 21.6 kg. The molecular weight of these non melt processible polymers cannot be measured by conventional techniques. Thus, an indirect method that correlates with molecular weight, such as standard specific gravity (SSG) is used. The lower the SSG value, the higher the average molecular weight. The SSG of the core shell fluoropolymer is typically no greater than 2.200, 2.190, 2.185, 2.180, 2.170, 2.160, 2.157, 2.150, 2.145, or even 2.130 g/cm³ as measured according to ASTM D4895-04.

In some embodiments, the core shell fluoropolymer comprises polymerized units of HFP. The amount of polymerized units of HFP can be at least 1, 2, 3, 4, 5 wt. % of the total core shell fluoropolymer. In some embodiments, the amount of polymerized units of HFP is no greater than 15, 14, 13, 12, 11, or 10 wt. % of the total core shell fluoropolymer.

In some embodiments, the core shell fluoropolymer comprises little or no polymerized units of vinylidene fluoride (VDF) (i.e. CH₂═CF₂) or VDF coupled to hexafluoropropylene (HFP). Polymerized units of VDF can undergo dehydrofluorination (i.e. an HF elimination reaction) as described in US2006/0147723. The reaction is limited by the number of polymerized VDF groups coupled to an HFP group contained in the fluoropolymer.

In some embodiments, the amount of polymerized units of VDF is zero or no greater than 5, 4, 3, 2, 1, 0.05, wt. % of the total core shell fluoropolymer.

The core shell fluoropolymers may or may not contain partially fluorinated or non-fluorinated comonomers and combinations thereof. Although this is not preferred for minimizing the dielectric constant, inclusion of such monomer can improve the melt processibility. Typical partially fluorinated comonomers include but are not limited to 1,1-difluoroethene (vinylidenefluoride, VDF) and vinyl fluoride (VF) or trifluorochloroethene or trichlorofluoroethene. Examples of non-fluorinated comonomers include but are not limited to ethene and propene. In typical embodiments, the fluoropolymer composition comprises no greater than 25, 20, 15, or 10 wt.-% of polymerized units derived from non-fluorinated or partially fluorinated monomers based on the total weight of the fluoropolymer. In some embodiments, the fluoropolymer composition comprises no greater than 9, 8, 7, 6, 5, 4, 3, 2, 1 or 0.1 wt.-% of polymerized units derived from non-fluorinated or partially fluorinated monomers based on the total weight of the fluoropolymer.

In typical embodiments, the amount of polymerized units that are not fully fluorinated, or in other words contains hydrogen atoms, is zero or no greater than 5, 4, 3, 2, 1, 0.05, wt. % of the total core shell fluoropolymer. One illustrative comonomer that is not fully fluorinated is (perfluoroalkyl)ethylene represented by the formula CH₂═CH—Rf wherein Rf is a perfluoroalkyl group with 1 to 10 carbon atoms such as 1,1,3,3,3-pentafluoro-1propylene and 1,2,3,3,3-pentafluoro-1-propylene.

The core shell fluoropolymers described herein further comprise polymerized units of a comonomer comprising a functional group. Suitable functional groups include for example nitrile, halogen (e.g. iodine, bromine or chlorine) sulfur oxide, perfluorinated alkyl ether, and carbonyl. The core shell fluoropolymer contains polymerized units of comonomer comprising a functional group in the backbone, as pendent groups, or at a terminal position. In some embodiments, the core shell fluoropolymers comprises a polymerized units of a comonomer comprising a precursor that can be converted into a functional group or a first functional group that can be converted to a second functional group.

In typical embodiments the core shell fluoropolymer comprises up to 1 wt. % of polymerized units of a comonomer comprising functional groups. The minimum amount of polymerized units of a comonomer comprising functional groups can vary depending on the functional group and desired technical effect. In some embodiments, the amount of polymerized units comprising functional groups is at least 0.001, 0.002, 0.003, 0.004, 0.005, 0.006, 0.007, 0.008, 0.009, or 0.01 wt.-% of the core shell fluoropolymer. Notably core shell fluoropolymers with 0.006 wt. % of polymerized units of a comonomer comprising nitrile or sulfur oxide functional groups were found to improve adhesion. In other embodiments, the amount of polymerized units comprising functional groups is at least 0.02, 0.03, 0.04. 0.05, 0.06, 0.07, 0.08, 0.09 or 0.1 wt. % of the core shell fluoropolymer. In yet other embodiments, the amount of polymerized units comprising functional groups is at least 0.20, 0.30, 0.4, 0.5, 0.6, 0.7, 0.8, or 0.9 wt. % of the core shell fluoropolymer. For optimal electrical properties, if is preferred to minimize the amount of polymerized units of a comonomer comprising functional groups. Thus, in some embodiments, the core shell fluoropolymer comprises no greater than 0.9, 0.8, 0.7, 0.6, 0.5, 0.4, 0.3, 0.2, 0.1, 0.05, 0.01 wt. % of polymerized units of a comonomer comprising functional groups.

In some embodiments, the core shell fluoropolymer comprises up to 1 wt. % of a single type of functional group. In other embodiments, the core shell fluoropolymer comprises up to 1 wt.-% of any combination of different types of functional groups. One embodied combination comprises nitrile functional groups and perfluorinated alkyl ether. Other embodied combination include halogen and nitrile functional groups. In some embodiments, the core shell fluoropolymer comprising a combination of functional groups may be characterized as a dual curing, containing different cure sites that are reactive to different curing systems.

In typical embodiments, the shell comprises the polymerized units of comonomer comprising functional groups. In some embodiments, the core comprises a portion of the polymerized units of a comonomer comprising functional groups.

### Comonomers Comprising a Halogen Functional Group

In some embodiments, the core shell fluoropolymer comprises polymerized units of a comonomer comprising halogen functional groups, i.e. cure sites comprising iodine, bromine or chlorine. The cure sites may be introduced into the polymer by using cure site monomers, i.e. functional monomers, functional chain-transfer agents and starter molecules as further described in PCT Application No. PCT/US2020/058660 (82669WO005).

In some embodiments, the functional groups comprise iodine or bromine atoms.

Iodine-containing end groups can be introduced by using an iodine-containing chain transfer agent in the polymerization. Halogenated redox systems may be used to introduce iodine end groups. Iodine and bromine functional groups may be introduced by cure-site monomers.

Examples of cure-site comonomers include for example:
(a) bromo- or iodo- (per)fluoroalkyl-(per)fluorovinylethers, for example including those having the formula:

ZRf—O—CX═CX₂

wherein each X may be the same or different and represents H or F, Z is Br or I, Rf is a C1-C12 (per)fluoroalkylene, optionally containing chlorine and/or ether oxygen atoms. Suitable examples include ZCF₂—O—CF═CF₂, ZCF₂CF₂—O—CF═CF₂, ZCF₂CF₂CF₂—O—CF═CF₂, CF₃CFZCF₂—O—CF═CF₂ or ZCF₂CF₂—O—CF₂CF₂CF₂—O—CF═CF₂ wherein Z represents Br of I; and
(b) bromo- or iodo perfluoroolefins such as those having the formula:

Z′—(Rf)r-CX═CX₂

wherein each X independently represents H or F, Z′ is Br or I, Rf is a C₁-C₁₂ perfluoroalkylene, optionally containing chlorine atoms and r is 0 or 1; and
(c) non-fluorinated bromo and iodo-olefins such as vinyl bromide, vinyl iodide, 4-bromo-1-butene and 4-iodo-1-butene.

Specific examples include but are not limited to compounds according to (b) wherein X is H, for example compounds with X being H and Rf being a C1 to C3 perfluoroalkylene. Particular examples include: bromo- or iodo-trifluoroethene, 4-bromo-perfluorobutene-1, 4-iodo-perfluorobutene-1, or bromo- or iodo-fluoroolefins such as 1-iodo,2,2-difluroroethene, 1-bromo-2,2-difluoroethene, 4-iodo-3,3,4,4,-tetrafluorobutene-1 and 4-bromo-3,3,4,4-tetrafluorobutene-1; 6-iodo-3,3,4,4,5,5,6,6-octafluorohexene-1.

In other embodiments, halogenated chain transfer agents can be utilized to provide terminal functional groups, otherwise known as cure sites. Chain transfer agents are compounds capable of reacting with the propagating polymer chain and terminating the chain propagation. Examples of chain transfer agents reported for the production of fluoroelastomers include those having the formula RIₓ, wherein R is an x-valent fluoroalkyl or fluoroalkylene radical having from 1 to 12 carbon atoms, which, may be interrupted by one or more ether oxygens and may also contain chlorine and/or bromine atoms. R may be Rf and Rf may be an x-valent (per)fluoroalkyl or (per)fluoroalkylene radical that may be interrupted once or more than once by an ether oxygen. Examples include alpha-omega diiodo alkanes, alpha-omega diiodo fluoroalkanes, and alpha-omega diiodoperfluoroalkanes, which may contain one or more catenary ether oxygens. “Alpha-omega” denotes that the iodine atoms are at the terminal positions of the molecules. Such compounds may be represented by the general formula X—R—Y with X and Y being I and R being as described above. Specific examples include di-iodomethane, alpha-omega (or 1,4-) diiodobutane, alpha-omega (or 1,3-) diiodopropane, alpha-omega (or 1,5-) diiodopentane, alpha-omega (or 1,6-) diiodohexane and 1,2-diiodoperfluoroethane. Other examples include fluorinated di-iodo ether compounds of the following formula:

R_{f}—CF(I)—(CX₂)ₙ—(CX₂CXR)ₘO—R″f-Oₖ—(CXR′CX₂)ₚ—(CX₂)_{q}—CF(I)—R′_{f}

wherein X is independently selected from F, H, and Cl; R_{f} and R′_{f} are independently selected from F and a monovalent perfluoroalkane having 1-3 carbons; R is F, or a partially fluorinated or perfluorinated alkane comprising 1-3 carbons; R″_{f} is a divalent fluoroalkylene having 1-5 carbons or a divalent fluorinated alkylene ether having 1-8 carbons and at least one ether linkage; k is 0 or 1; and n, m, and p are independently selected from an integer from 0-5, wherein, n plus m at least 1 and p plus q are at least 1.

In some embodiments, the cure sites comprise chlorine atoms. Such cure-site monomers include those of the general formula: CX₁X₂═CY₁Y₂ where X₁, X₂ are independently H and F; Y₁ is H, F, or Cl; and Y₂ is Cl, a fluoroalkyl group (R_{F}) with at least one Cl substituent, a fluoroether group (OR_{F}) with at least one Cl substituent, or —CF₂—OR_{F}. The fluoroalkyl group (R_{F}) is typically a partially or fully fluorinated C₁-C₅ alkyl group. Examples of cure-site monomer with chlorine atoms include CF₂═CFCl, CF₂═CF—CF₂C1, CF₂═CF—O—(CF₂)ₙ—Cl, n=1-4; CH₂═CHCl, CH₂═CCl₂.

The core shell fluoropolymer may exclusively comprise iodine, bromine, or chlorine. Alternatively, the core shell fluoropolymer may comprise any combination of halogen functional groups. Further, core shell fluoropolymer may exclusively comprise halogen functional groups or halogen functional groups in combination with other functional groups, i.e. nitrile, sulfur oxide, perfluorinated alkyl ether, carbonyl, or combinations thereof.

In other embodiments, the core shell fluoropolymer lacks halogen functional groups.

### Comonomers Comprising a Nitrile Functional Groups

In some embodiments, the core shell fluoropolymer comprises polymerized units of a comonomer comprising nitrile functional groups. Such nitrile functional group may be a precursor that converts to the corresponding amidines, amidine salts, imide, amides amide/imide and ammonium salts. Fluoropolymers with nitrile-containing functional groups, otherwise known as cure sites are known, such as described in U.S. Pat. Nos. 6,720,360 and 7,019,082.

Fluoropolymers with nitrile-containing cure sites are known, such as described in U.S. Pat. No. 6,720,360.

Nitrile-containing cure sites may be reactive to other cure systems for example, but not limited to, bisphenol curing systems, peroxide curing systems, triazine curing systems, and especially amine curing systems. Examples of nitrile containing cure site monomers correspond to the following formula:

CF₂═CF—CF₂—O—Rf—CN;

CF₂═CFO(CF₂)ᵣCN;

CF₂═CFO[CF₂CF(CF₃)O]ₚ(CF₂)ᵥOCF(CF₃)CN;

CF₂═CF[OCF₂CF(CF₃)]ₖO(CF₂)ᵤCN;

wherein, r represents an integer of 2 to 12; p represents an integer of 0 to 4; k represents 1 or 2; v represents an integer of 0 to 6; u represents an integer of 1 to 6, Rf is a perfluoroalkylene or a bivalent perfluoroether group. Specific examples of nitrile containing fluorinated monomers include but are not limited to perfluoro (8-cyano-5-methyl-3,6-dioxa-1-octene), CF₂═CFO(CF₂)₅CN, and CF₂═CFO(CF₂)₃OCF(CF₃)CN.

The core shell fluoropolymer may exclusively comprise nitrile functional groups or nitrile functional groups in combination with other functional groups, i.e. halogen, sulfur oxide, perfluorinated alkyl ether, carbonyl, or combinations thereof.

In other embodiments, the core shell fluoropolymer lacks nitrile functional groups.

### Comonomers Comprising Perfluorinated Alkyl Ethers Functional Group

In some embodiments, the core shell fluoropolymer comprises polymerized units of a comonomer comprising perfluorinated alkyl ethers functional groups. The comonomer may be an unsaturated perfluorinated alkyl ethers having the formula:

R_{f}—O—(CF₂)ₙ—CF═CF₂

wherein n is 1 (allyl ether) or 0 (vinyl ether) and R_{f} represents a perfluoroalkyl or perfluoroether group. R_{f} may contain up to 10 carbon atoms, e.g. 1, 2, 3, 4, 5, 6, 7, 8, 9 or 10 carbon atoms. Preferably R_{f} contains up to 8, more preferably up to 6 carbon atoms and most preferably 3 or 4 carbon atoms. In one embodiment R_{f} has 3 carbon atoms. In another embodiment R_{f} has 1 carbon atom. R_{f} may be linear or branched, and it may contain or not contain a cyclic unit. Specific examples of R_{f} include residues with one or more ether functions including but not limited to:
—(CF₂)—O—C₃F₇,
—(CF₂)₂—O—C₂F₅,
—(CF₂)ᵣ₃—O—CF₃,
—(CF₂—O)—C₃F₇,
—(CF₂—O)₂-C₂F₅,
—(CF₂—O)₃—CF₃,
—(CF₂CF₂—O)—C₃F₇,
—(CF₂CF₂—O)₂-C₂F₅,
—(CF₂CF₂—O)₃—CF₃,

Other specific examples for R_{f} include residues that do not contain an ether function and include but are not limited to —C₄F₉; —C₃F₇, —C₂F₅, —CF₃, wherein the C₄ and C₃ residues may be branched or linear, but preferably are linear.

The unsaturated perfluorinated alkyl either may comprise allyl or vinyl groups. Both have C—C double bonds. Whereas a perfluorinated vinyl group is CF₂═CF—; a perfluorinated allyl group is CF₂═CFCF₂—.

Specific examples of suitable perfluorinated alkyl vinyl ethers (PAVE's) and perfluorinated alkyl allyl ethers (PAAE's) include but are not limited to perfluoro (methyl vinyl) ether (PMVE), perfluoro (ethyl vinyl) ether (PEVE), perfluoro (n-propyl vinyl) ether (PPVE-1), perfluoro-2-propoxypropylvinyl ether (PPVE-2), perfluoro-3-methoxy-n-propylvinyl ether, perfluoro-2-methoxy-ethylvinyl ether, CF₂═CF—O—CF₂—O—C₂F₅, CF₂═CF—O—CF₂—O—C₃F₇, CF₃—(CF₂)₂—O—CF(CF₃)—CF₂—O—CF(CF₃)—CF₂—O—CF═CF₂ and their allyl ether homologues. Specific examples of allyl ethers include CF₂═CF—CF₂—O—CF₃, CF₂═CF—CF₂—O—C₃F₇, CF₂═CF—CF₂—O—(CF₃)₃—O—CF₃. Further examples include but are not limited to the vinyl ether described in European patent application EP 1,997,795 B1.

In some embodiments, the fluoropolymer comprises polymerized units of at least one allyl ether, such as alkyl vinyl ether is CF₂═CFCF₂OCF₂CF₂CF₃. Such fluoropolymers are described in WO 2019/161153, incorporated herein by reference.

Perfluorinated alkyl ethers as described above are commercially available, for example from Anles Ltd., St. Petersburg, Russia and other companies or may be prepared according to methods described in U.S. Pat. No. 4,349,650 (Krespan) or European Patent 1,997,795, or by modifications thereof as known to a skilled person.

The core shell fluoropolymers may or may not contain units derived from at least one modifying monomer that introduces branching sites into the polymer architecture. Typically, the modifying monomers are bisolefins, bisolefinic ethers or polyethers. The bisolefins and bisolefinic (poly)ethers may be perfluorinated, partially fluorinated or non-fluorinated. Preferably they are perfluorinated. Suitable perfluorinated bisolefinic ethers include those represented by the general formula:

CF₂═CF—(CF₂)ₙO—(Rf)—O—(CF₂)ₘ—CF═CF₂

wherein n and m are independent from each other either 1 or 0 and wherein Rf represents a perfluorinated linear or branched, cyclic or acyclic aliphatic or aromatic hydrocarbon residue that may be interrupted by one or more oxygen atoms and comprising up to 30 carbon atoms. A particular suitable perfluorinated bisolefinic ether is a di-vinylether represented by the formula:

CF₂═CF—O—(CF₂)ₙ—O—CF═CF₂

wherein n is an integer between 1 and 10, preferably 2 to 6., e.g. n may be 1, 2, 3, 4, 5, 6 or 7. More preferably, n represents an uneven integer, for example 1, 3, 5 or 7.

Further specific examples include bisolefinic ethers according the general formula

CF₂═CF—(CF₂)ₙ—O—(CF₂)ₚ—O—(CF₂)ₘ—CF═CF₂

wherein n and m are independently either 1 or 0 and p is an integer from 1 to 10 or 2 to 6. For example, n may be selected to represent 1, 2, 3, 4, 5, 6 or 7, preferably, 1, 3, 5 or 7.

Further suitable perfluorinated bisolefinic ethers can be represented by the formula

CF₂═CF—(CF₂)ₚ—O—(R_{af}O)ₙ(R_{bf}O)ₘ—(CF₂)_{q}—CF═CF₂

wherein R_{af} and R_{bf} are different linear or branched perfluoroalkylene groups of 1-10 carbon atoms, in particular, 2 to 6 carbon atoms, and which may or may not be interrupted by one or more oxygen atoms. R_{af} and/or R_{bf} may also be perfluorinated phenyl or substituted phenyl groups; n is an integer between 1 and 10 and m is an integer between 0 and 10, preferably m is 0. Further, p and q are independently 1 or 0.

In another embodiment, the perfluorinated bisolefinic ethers can be represented by the formula just described wherein m, n, and p are zero and q is 1-4.

Modifying monomers can be prepared by methods known in the art and are commercially available, for example, from Anles Ltd., St. Petersburg, Russia.

The core shell fluoropolymer may exclusively comprise perfluorinated alkyl ether functional groups or perfluorinated alkyl ether functional groups in combination with other functional groups, i.e. halogen, nitrile, sulfur oxide, carbonyl, or combinations thereof.

When the core of the core shell fluoropolymer comprises polymerized units of a comonomer comprising perfluorinated alkyl ether functional groups, the core and core shell fluoropolymer can be melt processible, i.e. having a melt flow index as previously described.

In other embodiments, the core shell fluoropolymer lacks perfluorinated alkyl ether functional groups.

### Comonomers Comprising Sulfur Oxide Functional Groups

In some embodiments, the core shell fluoropolymer comprises polymerized units of a comonomer comprising sulfur oxide functional. In some embodiments, the sulfur oxide groups are selected from —SO₂X¹, wherein X¹ is F or NH₂ or —SO₃X², wherein X² is H, Na, Li. One representative monomer includes MV4S [CF₂═CF—O—(CF₂)₄SO₂F]. In some embodiments, this monomer can hydrolyze resulting in fluorine group converting to —SO₃X², wherein X² is H, Na, Li.

The core shell fluoropolymer may exclusively comprise sulfur oxide functional groups or sulfur oxide functional groups in combination with other functional groups, i.e. halogen, nitrile, perfluorinated alkyl ether, and carbonyl.

In other embodiments, the core shell fluoropolymer lacks sulfur oxide functional groups.

### Comonomers Comprising Carbonyl Functional Groups

In some embodiments, the core shell fluoropolymer comprises polymerized units of a comonomer comprising a carbonyl functional group. Representative carbonyl functional groups include carbonate, a carboxy, haloformyl, carboxylic acid, acid anhydride, and the like.

Examples of acid anhydride monomers include for example itaconic anhydride, citraconic anhydride, and 5-norbornene-2,3-dicarboxylic acid anhydride, and maleic anhydride. In some embodiments, at least a portion of the acid anhydride groups can hydrolyze thereby forming dicarboxylic acid (e.g. itaconic acid, citraconic acid, 5-norbornene-2, 3-dicarboxylic acid, maleic acid, etc.).

In some embodiments, the functional groups promote adhesion to (e.g. copper) metal substrates. Functional groups can also react in the presence of a curing agent or a curing system to crosslink the fluoropolymers.

### Optional Curing Agent

In some embodiments, the fluoropolymer composition of the fluoropolymer layer lacks crosslinks of a chemical curing agent. In this embodiment, the fluoropolymer compositions described herein lacks chemical curing agents and/or the fluoropolymer(s) thereof lack cure sites that reacts with such chemical curing agent. It is appreciated that a chemical curing agent in the absence of a fluoropolymer with cure sites does not result in crosslinks of a chemical curing agent. It is also appreciated that a fluoropolymer with cure sites in the absence of a chemical curing agent does not result in crosslinks of a chemical curing agent. Thus, the fluoropolymer(s) may optionally contain one or more cure sites in the absence of a chemical curing agent. Alternatively, the fluoropolymer composition may optionally contain chemical curing agent in the absence of fluoropolymer with cure sites.

In some embodiments, the fluoropolymer composition lacks chemical curing agents, described in WO2021/091864, incorporated herein by reference. In this embodiment, the fluoropolymer lacks chemical curing agents such as a peroxides, amines, ethylenically unsaturated compounds; and amino organosilane ester compounds or ester equivalent. In this embodiment, the fluoropolymer composition also lacks one or more compounds comprising an electron donor group (such as an amine) in combination with an ethylenically unsaturated group.

In other embodiments, the fluoropolymer composition comprises a curing agent, such as the chemical curing agents just described. Other curing agents are described in WO 2020/132203; incorporated herein by reference. In one embodiment, a (e.g. semi crystalline) core shell fluoropolymer as described herein is combined with an amorphous fluoropolymer that comprises cure sites, the fluoropolymer composition may contain a chemical curing agent in order to crosslink the amorphous fluoropolymer and/or to crosslink the amorphous fluoropolymer with the (e.g. semicrystalline) core shell fluoropolymer.

### Optional Amorphous Fluoroelastomers

In some embodiment, the fluoropolymer layer comprise a (e.g. semi crystalline) core shell fluoropolymer comprising polymerized units of a comonomer comprising functional groups, as described herein in combination with an amorphous fluoropolymer.

In some embodiments, the amorphous fluoropolymer comprising polymerized units of comonomers include tetrafluoroethene (TFE) and one or more unsaturated perfluorinated (e.g. alkenyl, vinyl) alkyl ethers, as previously described, in an amount of at least 10, 15, 20, 25, 30, 45, or 50% by weight, based on the total polymerized monomer units of the fluoropolymer. When the amount of polymerized units derived from one or more of the unsaturated perfluorinated alkyl ethers is less than 30 wt %, the amorphous fluoropolymer typically comprises other comonomers such as HFP to reduce the crystallinity. In some embodiments, the amorphous fluoropolymer comprises no greater than 50, 45, 40, or 35% by weight of polymerized units derived from one or more of the unsaturated perfluorinated alkyl ethers (PMVE, PAAE or a combination thereof), based on the total polymerized monomer units of the fluoropolymer. The molar ratio of units derived from TFE to the perfluorinated alkyl ethers described above may be, for example, from 1:1 to 5:1. In some embodiments, the molar ratio ranges from 1.5:1 to 3:1.

As used herein, amorphous fluoropolymers are materials that contain essentially no crystallinity or possess no significant melting point (peak maximum) as determined by differential scanning calorimetry in accordance with DIN EN ISO 11357-3:2013-04 under nitrogen flow and a heating rate of 10° C./min. Typically, amorphous fluoropolymers have a glass transition temperature (Tg) of less than 26° C., less than 20° C., or less than 0° C., and for example from −40° C. to 20° C., or −50° C. to 15° C., or −55° C. to 10° C. The fluoropolymers may typically have a Mooney viscosity (ML 1+10 at 121° C.) of from about 2 to about 150, for example from 10 to 100, or from 20 to 70. For amorphous polymers containing cyclic perfluorinated alky ether units, the glass transition temperature is typically at least 70° C., 80° C., or 90° C., and may range up to 220° C., 250° C., 270° C., or 290° C. The MFI (297° C./5 kg) is between 0.1-1000 g/10 min.

The fluorine content of the amorphous fluoropolymer is typically at least 60, 65, 66, 67, 68, 69, or 70 wt. % of the fluoropolymer and typically no greater than 76, 75, 74, or 73 wt. %. The fluorine content may be achieved by selecting the comonomers and their amounts accordingly.

The amorphous fluoropolymers can be prepared by methods known in the art, such as bulk, suspension, solution or aqueous emulsion polymerization. (See for example EP 1,155,055; U.S. Pat. No. 5,463,021; WO 2015/088784 and WO 2015/134435) Various emulsifiers can be used as described in the art, including for example 3-perfluoro-3-(33-methoxy-propoxy)propanoic acid. For example, the polymerization process can be carried out by free radical polymerization of the monomers alone or as solutions, emulsions, or dispersions in an organic solvent or water. Seeded polymerizations may or may not be used. Curable fluoroelastomers that can be used also include commercially available fluoroelastomers, in particular perfluoroelastomers.

The fluoropolymers, including the core shell fluoropolymer, may have a monomodal or bi-modal or multi-modal weight distribution.

In one embodiment, a fluoropolymer blend is prepared by blending a latex containing first (e.g. semi crystalline) core shell fluoropolymer particles with a latex containing second (e.g. amorphous) fluoropolymer particles.

The latexes can be combined by any suitable manner such as by vortex mixing for 1-2 minutes. The method further comprises coagulating the mixture of latex particles. Coagulation may be carried out, for example, by chilling (e.g., freezing) the blended latexes or by adding a suitable salt (e.g., magnesium chloride) or inorganic acid. Chilling is especially desirable for coatings that will be used in semiconductor manufacturing and other applications where the introduction of salts may be undesirable. The method further comprising optionally washing the coagulated mixture of fluoropolymer particles. The washing step may substantially remove emulsifiers or other surfactants from the mixture and can assist in obtaining a well-mixed blend of substantially unagglomerated dry particles.

In some embodiments, the (e.g. semi crystalline) fluoropolymer particles, optional amorphous perfluoropolymer and blends thereof have very low amounts of fluorinated acids (for example, extractable C8-C14 alkanoic acids) and its salts, for example, less than 2000, 1000, 500, 100, 50, 25, or even 15 ppb (parts per billion) based on the weight of the polymer, which can be determined by extraction as described in U.S. Pat. No. 2019-0185599 (Hintzer et al.), herein incorporated by reference. The fluorinated acid corresponds to the general formula:

Y—R_{f}—Z-M

wherein Y represents hydrogen, Cl or F; R_{f} represents a divalent linear or branched or cyclic perfluorinated or partially fluorinated saturated carbon chain having 8 to 14 carbon atoms; Z represents an acid group, for example a —COO or a —SO₃ acid group, and M represents a cation including H⁺.

The method further comprises drying the coagulated latex mixture. The coagulated latex mixture can be dried by any suitable means such as air drying or oven drying. In one embodiment, the coagulated latex mixture can be dried at 100° C. for 1-2 hours.

In other embodiments, the (e.g. semi crystalline) core shell fluoropolymer latex particles can be coagulated, washed, and dried separately from the latex containing second (e.g. amorphous) fluoropolymer particles. The dried core shell (e.g. semi crystalline) fluoropolymer latex particles can be dry blended with the dried amorphous fluoropolymer particles, as described in WO2020/132203.

In some embodiments, the dried latex particles can be thermally processed.

In other embodiments, the dried e.g. semi crystalline) core shell fluoropolymer latex particles can be added to a coating solution comprising the amorphous fluoropolymer and a fluorinated solvent.

### Coating Solutions of Amorphous Fluoropolymer & Core Shell Fluoropolymer Particles

The (e.g. semi-crystalline) core shell fluoropolymer particles are insoluble in fluorinated solvent and are also insoluble in non-fluorinated organic solvent such as methyl ethyl ketone (“MEK”), tetrahydrofuran (“THF”), ethyl acetate or N-methyl pyrrolidinone (“NMP”). By insoluble it is meant that less than 1, 0.5, 0.1, 0.01, 0.001 wt. % of the fluoropolymer is soluble in fluorinated solvent.

However, the amorphous fluoropolymer is soluble in fluorinated solvent. Thus, fluoropolymer coating compositions may be prepared by first dissolving an amorphous fluoropolymer in fluorinated solvent and then dispersing the core shell fluoropolymer particles and other additives added thereafter.

The fluorinated solvent is typically present in an amount of at least 25% by weight based on the total weight of the coating composition. In some embodiments, the solvent is present in an amount of at least 30, 35, 40, 45, 50, 55, 60, 65, 70, 75, 80, 85, 90, 95% or greater based on the total weight of the coating composition.

The fluoropolymer coating composition typically comprises at least 0.1, 0.5, 1, 2, 3, 4, or 5 wt. % amorphous fluoropolymer, based on the weight of the total coating composition. In some embodiments, the fluoropolymer coating composition comprises at least 6, 7, 8, 9 or 10 wt. % of amorphous fluoropolymer. The fluoropolymer coating composition typically comprises no greater than 50, 45, 40, 35, 30, 25, or 20 wt. % by weight of amorphous fluoropolymer.

Optimum amounts of solvent and fluoropolymers may depend on the final application and may vary. For example, to provide thin coatings, very dilute solutions may be desired, for example amounts of from 0.01% by weight to 5% by weight of amorphous fluoropolymer. Also for application by spray coating composition of low viscosity may be preferred over solutions with high viscosity. The concentration of fluoropolymer in the solution affects the viscosity and may be adjusted accordingly.

In some embodiments, the fluoropolymer coating compositions may be liquids. The liquids may have, for example, a viscosity of less than 2,000 mPas at room temperature (20° C.+/−2° C.). In other embodiments, the fluoropolymer coating solution compositions are pastes. The pastes may have, for example, a viscosity of from 2,000 to 100.000 mPas at room temperature (20° C.+/−2° C.).

The solvent is a liquid at ambient conditions and typically has a boiling point of greater than 50° C. Preferably, the solvent has a boiling point below 200° C. so that it can be easily removed. In some embodiments, the solvent has a boiling point below 190, 180, 170, 160, 150, 140, 130, 120, 110, or 100° C.

In some embodiments, the fluorinated solvent is partially fluorinated or perfluorinated. Thus, the solvent is non-aqueous. Various partially fluorinated or perfluorinated solvents are known including perfluorocarbons (PFCs), hydrochlorofluorocarbons (HCFCs), perfluoropolyethers (PFPEs), and hydrofluorocarbons (HFCs), as well as fluorinated ketones and fluorinated alkyl amines.

In some embodiments, the solvent comprises a partially fluorinated ether or a partially fluorinated polyether. The partially fluorinated ether or polyether may be linear, cyclic or branched. Preferably, it is branched. Preferably it comprises a non-fluorinated alkyl group and a perfluorinated alkyl group and more preferably, the perfluorinated alkyl group is branched.

In one embodiment, the partially fluorinated ether or polyether solvent corresponds to the formula:

Rf—O—R

wherein Rf is a perfluorinated or partially fluorinated alkyl or (poly)ether group and R is a non-fluorinated or partially fluorinated alkyl group. Typically, Rf may have from 1 to 12 carbon atoms. Rf may be a primary, secondary or tertiary fluorinated or perfluorinated alkyl residue. This means, when Rf is a primary alkyl residue the carbon atom linked to the ether atoms contains two fluorine atoms and is bonded to another carbon atom of the fluorinated or perfluorinated alkyl chain. In such case Rf would correspond to R_{f}¹—CF₂— and the polyether can be described by the general formula: R_{f}¹—CF₂—O—R.

When Rf is a secondary alkyl residue, the carbon atom linked to the ether atom is also linked to one fluorine atoms and to two carbon atoms of partially and/or perfluorinated alkyl chains and Rf corresponds to (R_{f}²R_{f}³)CF—. The polyether would correspond to (R_{f}²R_{f}³)CF—O—R.

When Rf is a tertiary alkyl residue the carbon atom linked to the ether atom is also linked to three carbon atoms of three partially and/or perfluorinated alkyl chains and Rf corresponds to (R_{f}⁴R_{f}⁵/R_{f}⁶)—C—. The polyether then corresponds to (R_{f}⁴R_{f}⁵R_{f}⁶)—C—OR. R_{f}¹; R_{f}²; R_{f}³; R_{f}⁴; R_{f}⁵; R_{f}⁶ correspond to the definition of Rf and are a perfluorinated or partially fluorinated alkyl group that may be interrupted once or more than once by an ether oxygen. They may be linear or branched or cyclic. Also a combination of polyethers may be used and also a combination of primary, secondary and/or tertiary alkyl residues may be used.

An example of a solvent comprising a partially fluorinated alkyl group includes C₃F₇OCHFCF₃ (CAS No. 3330-15-2).

An example of a solvent wherein Rf comprises a perfluorinated (poly)ether is C₃F₇OCF(CF₃)CF₂OCHFCF₃ (CAS No. 3330-14-1).

In some embodiments, the partially fluorinated ether solvent corresponds to the formula:

CpF2p+1-O-CqH2q+1

wherein q is an integer from 1 to and 5, for example 1, 2, 3, 4 or 5, and p is an integer from 5 to 11, for example 5, 6, 7, 8, 9, 10 or 11. Preferably, CₚF₂ₚ₊₁ is branched. Preferably, CₚF₂ₚ₊₁ is branched and q is 1, 2 or 3.

Representative solvents include for example 1,1,1,2,2,3,4,5,5,5-decafluoro-3-methoxy-4-(trifluoromethyl)pentane and 3-ethoxy-1,1,1,2,3,4,4,5,5,6,6,6-dodecafluroro-2-(trifluoromethyl)hexane. Such solvents are commercially available, for example, under the trade designation NOVEC from 3M Company, St. Paul, MN.

### Additives

Compositions containing the core shell fluoropolymer described herein may further contain additives as known in the art. Illustrative additives include for example acid acceptors, stabilizers, surfactants, ultraviolet (“UV”) absorbers, antioxidants, plasticizers, lubricants, fillers, and processing aids, colorants including pigments (e.g. carbon black, graphite, soot, iron oxide, titanium dioxides). Filler include but are not limited to clay, silicon dioxide, barium sulphate, silica, glass fibers, or other additives known and used in the art.

Acid acceptors can be inorganic or blends of inorganic and organic acid acceptors. Examples of inorganic acceptors include magnesium oxide, lead oxide, calcium oxide, calcium hydroxide, dibasic lead phosphate, zinc oxide, barium carbonate, strontium hydroxide, calcium carbonate, hydrotalcite, etc. Organic acceptors include epoxies, sodium stearate, and magnesium oxalate. Particularly suitable acid acceptors include magnesium oxide and zinc oxide. Blends of acid acceptors may be used as well. The amount of acid acceptor will generally depend on the nature of the acid acceptor used. Typically, the amount of acid acceptor used is between 0.5 and 5 parts per 100 parts of fluorinated polymer.

In preferred embodiments, fillers that are not acid acceptors can provide better electrical properties.

In some embodiments, the fluoropolymer composition further comprises silica, glass fibers, thermally conductive particles, or a combination thereof. Any amount of silica and/or glass fibers and/or thermally conductive particles may be present.

In some embodiments, the amount of silica and/or glass fibers is at least 0.05, 0.1, 0.2, 0.3 wt. % of the total solids of the composition. In some embodiments, the amount of silica and/or glass fibers is no greater than 5, 4, 3, 2, or 1 wt. % of the total solids of the composition. Small concentrations of silica can be utilized to thicken the coating composition. Further, small concentrations of glass fibers can be used to improve the strength of the fluoropolymer film.

In other embodiments, the amount of glass fibers can be at least 5, 10, 15, 20, 25, 35, 40, 45 or 50 wt.-% of the total solids of the composition. The amount of glass fibers is typically no greater than 55, 50, 45, 40, 35, 25, 20, 15, or 10 wt. %. In some embodiments, the glass fibers have a mean length of at least 100, 150, 200, 250, 300, 350, 400, 450, 500 microns. In some embodiments, the glass fibers have a mean length of at least 1, 2, or 3 mm and typically no greater than 5 or 10 mm. In some embodiments, the glass fibers have a mean diameter of at least 1, 2, 3, 4, or 5 microns and typically no greater than 10, 15, 30, or 25 microns. The glass fibers can have aspect ratio of at least 3:1, 5:1, 10:1, or 15:1.

In some embodiments, the fluoropolymer composition is free of (e.g. silica) inorganic oxide particles. In other embodiments, the fluoropolymer composition comprises (e.g. silica and/or thermally conductive) inorganic oxide particles. In some embodiments, the amount of (e.g. silica and/or thermally conductive) inorganic oxide particles is at least 5, 10, 15, 20, 25, 30, 35, 40, 45 or 50 wt. % of the total solids of the composition. In some embodiments, the amount of (e.g. silica and/or thermally conductive) inorganic oxide particles is no greater than 90, 85, 80, 75, 70, or 65 wt. % of the total solids of the composition. Various combinations of silica and thermally conductive particles can be utilized. In some embodiments, the total amount of (e.g. silica and thermally conductive) inorganic oxide particles or the amount of a specific type of silica particle (e.g. fused silica, fumed silica, glass bubbles, etc.) or thermally conductive particle (e.g. boron nitride, silicon carbide, aluminum oxide, aluminum trihydrate) is no greater than 60, 55, 50, 45, 40, 35, 30, 25, 20, 15, 10, or 5 wt. % of the total solids of the composition. Higher concentrations of (e.g. silica) inorganic oxide particles can be favorable to further reducing the dielectric properties. Thus, the compositions including (e.g. silica) inorganic oxide particles can have even lower dielectric properties than the fluoropolymer composition alone.

In some embodiments, the (e.g. silica) inorganic oxide particles and/or glass fibers have a dielectric constant at 1 GHz of no greater than 7, 6.5, 6, 5.5, 5, 4.5, or 4. In some embodiments, the (e.g. silica) inorganic oxide particles and/or glass fibers have a dissipation factor at 1 GHz of no greater than 0.005, 004, 0.003, 0.002, or 0.0015.

In some embodiments, the composition comprises inorganic oxide particles or glass fibers that comprise predominantly silica. In some embodiments, the amount of silica is typically at least 50, 60, 70, 75, 80, 85, or 90 wt. % of the inorganic oxide particles or glass fibers, in some embodiments, the amount of silica is typically at least 90, 91, 92, 93, 94, 95, 96, 97, 98, 99, or greater (e.g. at least 99.5, 99.6, or 99.7) wt. % silica. Higher silica concentrations typically have lower dielectric constants. In some embodiments, (e.g. fused) silica particle can further comprise small concentration of other metals/meta oxides such as Al₂O₃, Fe₂O₅, TiO₂, K₂O, CaO, MgO and Na₂O. In some embodiments, the total amount of such metals/metal oxides (e.g. Al₂O₃, CaO and MgO) is independently no greater than 30, 25, 20, 15, or 10 wt. %. In some embodiments, the inorganic oxide particles or glass fibers may comprise B₂O₃. The amount of B₂O₃ can range up to 25 wt. % of the inorganic oxide particles or glass fibers. In other embodiments, (e.g. fumed) silica particle can further comprise small concentration of additional metals/metal oxides such as Cr, Cu, Li, Mg, Ni, P and Zr. In some embodiments, the total amount of such metals or metal oxides is no greater 5, 4, 3, 2, or 1 wt. %. In some embodiments, the silica may be described as quartz. The amount of non-silica metals or metal oxides can be determined by uses of inductively coupled plasma mass spectrometry. The (e.g. silica) inorganic oxides particles are typically dissolved in hydrofluroic acid and distilled as H₂SiF₆ at low temperatures.

In some embodiments, the inorganic particles may be characterized as an “agglomerate”, meaning a weak association between primary particles such as particles held together by charge or polarity. Agglomerate are typically physically broken down into smaller entities such as primary particles during preparation of the coating. In other embodiments, the inorganic particles may be characterized as an “aggregate”, meaning strongly bonded or fused particles, such as covalently bonded particles or thermally bonded particles prepared by processes such as sintering, electric arc, flame hydrolysis, or plasma. Aggregates are typically no broken down into smaller entities such as primary particles during preparation of the coating or thermal processing. “Primary particle size” refers to the mean diameter of a single (non-aggregate, non-agglomerate) particle.

The (e.g. silica) particles may have various shapes such as spherical, ellipsoid, linear or branched. Fused and fumed silica aggregates are more commonly branched. The aggregate size is commonly at least 10× the primary particle size of discrete part.

In other embodiments, the (e.g. silica) particles may be characterized as glass bubbles. The glass bubble may be prepared from soda lime borosilicate glass. In this embodiment, the glass may contain about 70 percent silica (silicon dioxide), 15 percent soda (sodium oxide), and 9 percent lime (calcium oxide), with much smaller amounts of various other compounds.

In some embodiments, the inorganic oxide particles may be characterized as (e.g. silica) nanoparticles, having a mean or median particles size less than 1 micron. In some embodiments, the mean or median particle size of the (e.g. silica) inorganic oxide particles is at 500 or 750 nm. In other embodiments, the mean particle size of the (e.g. silica) inorganic oxide particles may be at least 1, 1.5, 2, 2.5, 3, 3.5, 4, 4.5, 5, 5.5, 6, 6.5, 7, 7.5, 8, 8.5, 9, 9.5 or 10 microns. In some embodiments, the mean particle size in no greater than 30, 25, 20, 15, or 10 microns. In some embodiments, the composition comprises little or no (e.g. colloidal silica) nanoparticles having a particle of 100 nanometers or less. The concentration of (e.g. colloidal silica) nanoparticles is typically less than (10, 9, 8, 7, 6, 5, 4, 3, 2, or 1 wt. %) The inorganic oxide (e.g. silica particle) may comprise a normal distribution of particle sizes having a single peak or a distribution of particles having two or more peaks.

In some embodiments, no greater than 1 wt. % of the (e.g. silica) inorganic oxide particles have a particle size greater than or equal to 3 or 4 microns. In some embodiments, no greater than 1 wt. % of the (e.g. silica) inorganic oxide particles have a particle size greater than or equal to 5 or 10 microns. In other embodiments, no greater than 5, 4, 3, 2, or 1 wt. % of the particles have a particle size greater than 45 microns. In some embodiments, no greater than 1 wt. % of the particles have a particle size ranging from 75 to 150 microns.

In some embodiments, the mean or median particle size refers to the “primary particle size” referring to the mean or median diameter of discrete a non-aggregated, non-agglomerated particles. For example, the particle size of colloidal silica or glass bubbles is typically the mean or median primary particle size. In preferred embodiments, the mean or median particle size refers to the mean or median diameter of the aggregates. The particle size of the inorganic particles can be measured using transmission electron microscopy. The particle size of the fluoropolymer coating dispersion can be measured using dynamic light scattering.

In some embodiments, the (e.g. silica) inorganic particles have a specific gravity ranging from 2.18 to 2.20 g/cc.

Aggregated particles, such as in the case of fumed and fused (e.g. silica) particles, can have a lower surface area than primary particles of the same size. In some embodiments, the (e.g. silica) particle have a BET surface area ranging from about 50 to 500 m²/g. In some embodiments, the BET surface area is less than 450, 400, 350, 300, 250, 200, 150, or 100 m²/g. In some embodiments, the inorganic nanoparticles may be characterized as colloidal silica. It is appreciated that unmodified colloidal silica nanoparticles commonly comprise hydroxyl or silanol functional groups on the nanoparticle surface and are typically characterized as hydrophilic.

In some embodiments, (e.g. silica aggregate) inorganic particles and especially colloidal silica nanoparticles are surface treated with a hydrophobic surface treatment. Common hydrophobic surface treatments include compounds such as alkoxysilanes (e.g. octadecytriethoxysilane), silazane, or siloxanes. Various hydrophobic fumed silicas are commercially available from AEROSIL™, Evonik, and various other suppliers. Representative hydrophobic fumed silica include AEROSIL™ grades R 972, R 805, RX 300, and NX 90 S.

In some embodiments, (e.g. silica aggregate) inorganic particles are surface treated with a fluorinated alkoxysilane silane compound. Such compounds typically comprise a perfluoroalkyl or perfluoropolyether group. The perfluoroalkyl or perfluoropolyether group typically has no greater than 4, 5, 6, 7, 8 carbon atoms. The alkoxysilane group can be bonded to the alkoxy silane group with various divalent linking groups including alkylene, urethane, and —SO₂N(Me)-. Some representative fluorinated alkoxy silanes are described in U.S. Pat. No. 5,274,159 and WO 2011/043973; incorporated herein by reference. Other fluorinated alkoxy silanes are commercially available.

In some embodiments, the fluoropolymer composition comprises thermally conductive particles.

In some embodiments, the thermally conductive inorganic particles are preferably an electrically non-conductive material. Suitable electrically non-conductive, thermally conductive materials include ceramics such as metal oxides, hydroxides, oxyhydroxides, silicates, borides, carbides, and nitrides. Suitable ceramic fillers include, e.g., silicon oxide, zinc oxide, alumina trihydrate (ATH) (also known as hydrated alumina, aluminum oxide, and aluminum trihydroxide), aluminum nitride, boron nitride, silicon carbide, and beryllium oxide. Other thermally conducting fillers include carbon-based materials such as graphite and metals such as aluminum and copper. Combinations of different thermally conductive materials may be utilized. Such materials are not electrically conductive, i.e. have an electronic band gap greater than 0 eV and in some embodiments, at least 1, 2, 3, 4, or 5 eV. In some embodiments, such materials have an electronic band gap no greater than 15 or 20 eV. In this embodiment, the composition may optionally further comprise a small concentration of thermally conductive particles having an electronic band gap of less than 0 eV or greater than 20 eV.

In favored embodiments, the thermally conductive particles comprise a material having a bulk thermal conductivity >10 W/m*K. The thermal conductivity of some representative inorganic materials is set forth in the following table.

Thermally Conductive Materials

| | Thermal | Electronic | | |
|---|---|---|---|---|
| | Conductivity | Band Gap | | |
| Material | (W/m*K) | (eV) | Density | |
| α-Aluminum Oxide¹ | 30 | 5-9 | 3.95 | g/cc |
| Alumina Trihydrate² | 21 | | 2.42-2.45 | g/cc |
| Silicon Carbide (SiC)¹ | 120 | 2.4 | 3.21 | g/cc |
| Hexagonal Boron Nitride | 185-300 | 2.1 | 2.1 | g/cc |

(BN)¹

In some embodiments, the thermally conductive particles comprise material(s) having a bulk thermal conductivity of at least 15 or 20 W/m*K. In other embodiments, the thermally conductive particles comprise material(s) having a bulk thermal conductivity of at least 25 or 30 W/m*K. In yet other embodiments, the thermally conductive particles comprise material(s) having a bulk thermal conductivity of at least 50, 75 or 100 W/m*K. In yet other embodiments, the thermally conductive particles comprise material(s) having a bulk thermal conductivity of at least 150 W/m*K. In typical embodiments, the thermally conductive particles comprise material(s) having a bulk thermal conductivity of no greater than about 350 or 300 W/m*K.

Thermally conductive particles are available in numerous shapes, e.g. spheres and acicular shapes that may be irregular or plate-like. In some embodiments, the thermally conductive particles are crystals, typically have a geometric shape. For example, boron nitride hexagonal crystals are commercially available from Momentive. Further, alumina trihydrate is described as a hexagonal platelet. Combinations of particles with different shapes may be utilized. The thermally conductive particles generally have an aspect ratio less than 100:1, 75:1, or 50:1. In some embodiment, the thermally conductive particles have an aspect ratio less than 3:1, 2.5:1, 2:1, or 1.5:1. In some embodiments, generally symmetrical (e.g., spherical, semi-spherical) particles may be employed.

Boron nitride particles are commercially available from 3M as “3M™ Boron Nitride Cooling Fillers”.

In some embodiments, the boron nitride particles has a bulk density of at least 0.05, 0.01, 0.15, 0.03 g/cm³ ranging up to about 0.60, 0.70, or 0.80 g/cm³. The surface area of the boron nitride particle can be <25, <20, <10, <5, or <3 m²/g. The surface area is typically at least 1 or 2 m²/g.

In some embodiments, the particle size, d(0.1), of the boron nitride (e.g. platelet) particles ranges from about 0.5 to 5 microns. In some embodiments, the particle size, d(0.9), of the boron nitride (e.g. platelet) particles is at least 5 ranging up to 20, 25, 30, 35, 40, 45, or 50 microns.

### Methods of Making Coated Substrates

In some embodiments, a method of making a coated substrate is described comprising providing a fluoropolymer composition comprising a (e.g. semi crystalline) core shell fluoropolymer as described herein; and applying the fluoropolymer composition to a substrate.

In typical embodiments, the fluoropolymer composition is prepared by providing a (e.g. semi crystalline) core shell fluoropolymer or blend of a first (e.g. semi crystalline) core shell fluoropolymer (e.g. particles) and second amorphous fluoropolymer and thermally extruding the fluoropolymer composition onto the substrate. The extrusion temperature is above the melt temperature of the fluoropolymer(s).

The fluoropolymers and optional additives can be combined in conventional rubber processing equipment to provide a solid mixture, i.e. a solid polymer containing the additional ingredients, also referred to in the art as a “compound”. Typical equipment includes rubber mills, internal mixers, such as Banbury mixers, and mixing extruders. During mixing the components and additives are distributed uniformly throughout the resulting fluorinated polymer “compound” or polymer sheets. The compound is then preferably comminuted, for example by cutting it into smaller pieces.

In yet another embodiment, the method comprises a laminating a fluoropolymer film to the substrate with heat and pressure. The fluoropolymer film can be heated laminated at temperatures ranging from 120° C. to 350° C. In some embodiments, the fluoropolymer film can be heat laminated at a temperature less than 325 or 300°. In some embodiments, the fluoropolymer film can be eat laminated at a temperature no greater than 290, 280, 270, 260, 250, 240, 230, 220, 210, or 200° C. Lower temperatures are amenable to bonding heat sensitive substrate and reducing manufacturing energy costs. The fluoropolymer film may be provided by extrusion coating on a release liner.

The compositions may be used for impregnating substrates, printing on substrates (for example screen printing), or coating substrates, for example but not limited to spray coating, painting dip coating, roller coating, bar coating, solvent casting, paste coating. The substrate may be organic, inorganic, or a combination thereof. Suitable substrates may include any solid surface and may include substrate selected from glass, plastics (e.g. polycarbonate), composites, metals (stainless steel, aluminum, carbon steel), metal alloys, wood, paper among others. The coating may be colored in case the compositions contains pigments, for example titanium dioxides or black fillers like graphite or soot, or it may be colorless in case pigments or black fillers are absent.

Bonding agents and primers may be used to pretreat the surface of the substrate before coating. For example, bonding of the coating to metal surfaces may be improved by applying a bonding agent or primer. Examples include commercial primers or bonding agents, for example those commercially available under the trade designation CHEMLOK.

In other embodiments, the fluoropolymer composition further comprises an amorphous fluoropolymer and fluorinated solvent. In this embodiment, the method further comprises removing the fluorinated solvent after applying the fluoropolymer composition to the substrate.

The fluoropolymer coating compositions described herein may be adjusted (by the solvent content) to a viscosity to allow application by different coating methods, including, but not limited to spray coating or printing (for example but not limited to ink-printing, 3D-printing, screen printing), painting, impregnating, roller coating, bar coating, dip coating and solvent casting.

The solvent may be reduced or completely removed, for example for evaporation, drying or by boiling it off After removal of the solvent the composition may be characterized as “dried”. The coated substrate may be dried at temperatures at or above the boiling point of the fluorinated solvent. In some embodiments, the method further comprises heating the substrate comprising the fluoropolymer composition to a temperature above the melt temperature of the fluoropolymer particles to sinter the fluoropolymer particles.

The fluoropolymer can exhibit good adhesion to various substrates (e.g. glass, polycarbonate, and metals, such as copper. In some embodiment, the substrate has an average peak to valley height surface roughness (i.e. Rz) of about 1 to 1.5 microns. In other embodiments, the substrate has an Rz of greater than 1.5, 2. 2.5, or 3 microns. In some embodiment, the substrate has an Rz) of no greater than 5, 4, 3, 2 or 1.5 microns. For example, in some embodiments, the T-peel to copper foil is at least 5, 6, 7, 8, 9 or 10 N/cm ranging up to 15, 20, 25 30, or 35 N/cm or greater as determined by the test method described in the examples. In one embodiment, the (e.g. core shell) fluoropolymer layer exhibits a bond strength to copper of at least 5 N when heat laminated at a temperature no greater than 360° C. for 30 minutes at a pressure of 54 barr.

In some embodiments, the fluoropolymer composition dried has hydrophobic and oleiphobic properties, as determined by Contact Angle Measurements (as determined according to the test method described in the examples). In some embodiments, the static, advancing and/or receding contact angle with water can be at least 100, 105, 110, 115, 120, 125 and typically no greater than 130 degrees. In some embodiments, the advancing and/or receding contact angle with hexadecane can be at least 60, 65, 70, or 75 degrees.

### Electronic Telecommunication Articles

The fluoropolymer compositions described herein are suitable for use in electronic telecommunication articles as described WO2021/091864; incorporated herein by reference. As used herein, electronic refers to devices using the electromagnetic spectrum (e.g. electrons, photons); whereas telecommunication is the transmission of signs, signals, messages, words, writings, images and sounds or information of any nature by wire, radio, optical or other electromagnetic systems.

Perfluoropolyners can have substantially lower dielectric constants and dielectric loss properties than polyimides which is particularly important for fifth generation cellular network technology (“5G”) articles. For example, fluoropolymer compositions described herein can have a dielectric constant (Dk) of less than 2.75, 2.70, 2.65, 2.60, 2.55, 2.50, 2.45, 2.40, 2.35, 2.30, 2.25, 2.20, 2.15, 2.10, 2.05, 2.00, or 1.95. In some embodiments, the dielectric constant is at least 2.02, 2.03, 2.04, 2.05. Further, the fluoropolymer compositions described herein can have a low dielectric loss, typically less than 0.01, 0.009, 0.008, 0.007, 0.006, 0.005, 0.004, 0.003, 0.002, 0.001, 0.0009, 0.0008, 0.0007, 0.0006, 0.0005, 0.0004, 0.0003. In some embodiments, the dielectric loss is at least 0.00022, 0.00023, 0.00024, 0.00025. The dielectric properties (e.g. constant and loss) can be determined according to the test method described in the examples. As the number of non-fluorine atoms decreases (e.g. number of carbon-hydrogen and/or carbon-oxygen bonds increases) the dielectric constant and dielectric loss also typically increases.

In one embodiment, the electronic telecommunication article is an integrated circuit or in other words a silicon chip or microchip, i.e. a microscopic electronic circuit array formed by the fabrication of various electrical and electronic components (resistors, capacitors, transistors, and so on) on a semiconductor material (silicon) wafer. Various integrated circuit designs have been described in the literature.

In some embodiments, particularly when it is desirable to apply a thin fluoropolymer film to the substrate, the method comprises applying a coating dispersion (e.g. spin coating) to a substrate. The coating solution comprises a fluorinated solvent, optionally an amorphous fluoropolymer, and a (e.g. semicrystalline) core shell fluoropolymer as described herein. The method typically comprises removing the fluorinated solvent (e.g. by evaporation). In this embodiment, the substrate or (e.g. SiO₂) coated surface thereof that comes in contact with the solvent is substantially insoluble in the fluorinated solvent of the coating solution. Further, the method typically comprises recycling, or in other words reusing, the fluorinated solvent of the coating solution.

In some embodiments, the fluoropolymer may be characterized are a patterned fluoropolymer layer. A patterned fluoropolymer lay may be formed by any suitable additive or subtractive method known in the art.

The patterned fluoropolymer layer can be used to fabricate other layers such as a circuit of patterned electrode materials. Suitable electrode materials and deposition methods are known in the art. Such electrode materials include, for example, inorganic or organic materials, or composites of the two. Exemplary electrode materials include polyaniline, polypyrrole, poly(3,4-ethylenedioxythiophene) (PEDOT) or doped conjugated polymers, further dispersions or pastes of graphite or particles of metal such as Au, Ag, Cu, Al, Ni or their mixtures as well as sputter-coated or evaporated metals such as Cu, Cr, Pt/Pd, Ag, Au, Mg, Ca, Li or mixtures or metal oxides such as indium tin oxide (ITO), F-doped ITO, GZO (gallium doped zinc oxide), or AZO (aluminium doped zinc oxide). Organometallic precursors may also be used and deposited from a liquid phase.

In another embodiment, a fluoropolymer layer can be disposed upon a metal (e.g. copper) substrate in the manufacture of a printed circuit board (PCB). A printed circuit board, or PCB, is used to mechanically support and electrically connect electronic components using conductive pathways, tracks or signal traces etched from (e.g. copper) metal sheets laminated onto a non-conductive substrate. Such boards are typically made from an insulating material such as glass fiber reinforced (fiberglass) epoxy resin or paper reinforced phenolic resin. The pathways for electricity can be made from a negative photoresist, as described in WO2021/091864. The amorphous fluoropolymer solution can further comprise (e.g. semicrystalline) core shell fluoropolymer particles as described herein. Thus, in this embodiment, the crosslinked fluoropolymer is disposed on the surface of the (e.g. copper) metal substrate. Portions of uncrosslinked fluoropolymer are removed to form the conductive (e.g. copper) pathways. Crosslinked fluoropolymer (e.g. photoresist) remain present, disposed between the conductive (e.g. copper) pathways of the printed circuit board. Solder is used to mount components on the surface of these boards. In some embodiments, the printed circuit board further comprises integrated circuits. Printed circuit board assemblies have an application in almost every electronic article including computers, computer printers, televisions, and cell phones.

In another embodiment, the fluoropolymer film described herein can be utilized as an insulating layer, passivation layer, and/or protective layer in the manufacture of integrated circuits.

In one embodiment, a thin fluoropolymer film (e.g. typically having a thickness less than 50, 40, or 30 nm) can be disposed on a passivation layer (e.g. SiO₂) disposed on an electrode patterned silicon chip.

In another embodiment, a thicker fluoropolymer film (e.g. typically having a thickness of at least 100, 200, 300, 400. 500 nm) can be disposed on an electrode patterned silicon chip. In this embodiment, the fluoropolymer layer may function as both a passivation layer and an insulating layer. Passivation is the use of a thin coating to provide electrical stability by isolating the transistor surface from electrical and chemical conditions of the environment.

In another embodiment, the fluoropolymer film described herein can be utilized as a substrate for antennas. The antenna of the transmitter emits (e.g. high frequency) energy into space while the antenna of the receiver catches this and converts it into electricity.

The patterned electrodes of an antenna can also be formed from photolithography. Screen printing, flexography, and ink jet printing can also be utilized to form the electrode pattern as known in the art. Various antenna designs for (e.g. mobile) computing devices (smart phone, tablet, laptop, desktop) have been described in the literature.

The low dielectric fluoropolymer films and coatings described herein can also be utilized as insulating and protective layers of transmitter antennas of cell towers and other (e.g. outdoor) as well as indoor structures.

In another embodiment, the low dielectric fluoropolymer compositions described herein may also be utilized in fiber optic cable. The low dielectric fluoropolymer compositions described herein can be used as the cladding, coating, outer jacket, or combination thereof.

In other embodiments, the low dielectric fluoropolymer films and coatings described herein can also be utilized for flexible cables and as an insulating film on magnet wire. For example, in a laptop computer, the cable that connects the main logic board to the display (which must flex every time the laptop is opened or closed) may be a low dielectric fluoropolymer composition as described herein with copper conductors.

The fluoropolymer films and coatings are typically not a sealing component of equipment used in wafer and chip production.

One of ordinary skill in the art appreciates that the low dielectric fluoropolymer compositions described herein can be utilized in various electronic telecommunication articles, particularly in place of polyimide, and such utility is not limited to the specific articles described herein.

As used herein the term “partially fluorinated alkyl” means an alkyl group of which some but not all hydrogens bonded to the carbon chain have been replaced by fluorine. For example, an F₂HC—, or an FH₂C— group is a partially fluorinated methyl group. Alkyl groups where the remaining hydrogen atoms have been partially or completely replaced by other atoms, for example other halogen atoms like chlorine, iodine and/or bromine are also encompassed by the term “partially fluorinated alkyl” as long as at least one hydrogen has been replaced by a fluorine. For example, residues of the formula F₂ClC— or FHClC— are also partially fluorinated alkyl residues.

A “partially fluorinated ether” is an ether containing at least one partially fluorinated group, or an ether that contains one or more perfluorinated groups and at least one non-fluorinated or at least one partially fluorinated group. For example, F₂HC—O—CH₃, F₃C—O—CH₃, F₂HC—O—CFH₂, and F₂HC—O—CF₃ are examples of partially fluorinated ethers. Ethers groups where the remaining hydrogen atoms have been partially or completely replaced by other atoms, for example other halogen atoms like chlorine, iodine and/or bromine are also encompassed by the term “partially fluorinated alkyl” as long as at least one hydrogen has been replaced by a fluorine. For example, ethers of the formula F₂ClC—O—CF₃ or FHClC—O—CF₃ are also partially fluorinated ethers.

The term “perfluorinated alkyl” or “perfluoro alkyl” is used herein to describe an alkyl group where all hydrogen atoms bonded to the alkyl chain have been replaced by fluorine atoms. For example, F₃C— represents a perfluoromethyl group.

A “perfluorinated ether” is an ether of which all hydrogen atoms have been replaced by fluorine atoms. An example of a perfluorinated ether is F₃C—O—CF₃.

The following examples are provided to further illustrate the present disclosure without any intention to limit the disclosure to the specific examples and embodiments provided.

### EXAMPLES

Unless otherwise noted, all parts, percentages, ratios, etc. in the Examples and the rest of the specification are by weight. Unless otherwise indicated, all other reagents were obtained, or are available from fine chemical vendors such as Sigma-Aldrich Company, St. Louis, Missouri, or may be synthesized by known methods. Table 1 (below) lists materials used in the examples and their sources.

TABLE 1
Materials List

| DESIGNATION | DESCRIPTION | SOURCE |
|---|---|---|
| ADONA | ADONA; Ether acid salt prepared as described | |
| | in Compound 11 of U.S. Pat. No. 7,671,112 | |
| | (Hintzer et al.) | |
| | 30 wt. % aqueous solution of ADONA | |
| | [CF₃—O—(CF₂)₃—O—CFH—CF₂COO⁻NH₄^{+]} | |
| | 10 wt. % aqueous tert. Butanol solution | Sigma-Aldrich |
| | Oxalic acid | Sigma-Aldrich |
| PPVE | PPVE (CF₂═CF—O—C₃F₇) | 3M Dyneon, |
| | | St. Paul, MN |
| TFE | Tetrafluoroethylene | 3M Dyneon |
| KMnO₄ | Potassium permanganate | Sigma-Aldrich |
| | CF₂═CF—O—(CF₂)₅CN | Anles Ltd., St. |
| | | Petersburg, Russia |
| APS | APS; Ammonium persulfate | Sigma-Aldrich |
| MV4S | MV4S [CF₂═CF—O—(CF₂)₄SO₂F]; Made as | |
| | described in the Example A to C of | |
| | U.S. Pat. No. 6,624,328 (Guerra). | |
| Kapton foil | Kapton foil, 300HN, 75 micrometers × 350 | Krempel GmbH, |
| | millimeters | Vaihingen\Enz. |
| | | Germany |
| | Copper foil, thickness 35 micrometers (μm) | |
| CFP-1 | 15 wt. % solids aqueous latex - 87 wt. % TFE | 3M Dyneon |
| | and 13 wt. % HFP; Melt Flow Index at 372° C. | |
| | and 5 kg load = 7 grams/10 minutes; Melting | |
| | point of 260° C. | |
| CFP-2 | 30 wt. % solids aqueous latex - 96 wt. % TFE, 4 | 3M Dyneon |
| | wt. % PPVE, Tm is 308° C., MFI (372° C./5 kg) | |
| | 7 g/10 minutes. | |

### Test Methods

Specific gravity was determined according to DIN EN ISO 12086-2:2006-05.

Particle size of dry powder can be measured by laser diffraction methods according to ISO 13320 (2009). The latex particle size determination can be conducted by means of dynamic light scattering with a Malvern Zetasizer 1000HSA (Malvern, Worcestershire, UK) as described in DIN ISO 13321:2004-10

### Vinyl and Allyl Ether Comonomer Content

For the melt-processible fluoropolymer particles, thin films of approximately 0.1 mm thickness were prepared by molding the coagulated, dried polymer at 350° C. using a heated plate press. For fluoropolymer particles that are not melt-processible, thin films of 0.3 to 0.4 mm thickness were prepared by cold compacting the polymer composition in a mold. These films were then scanned in nitrogen atmosphere using a Nicolet DX 510 FT-IR spectrometer. The OMNIC software (ThermoFisher Scientific, Waltham, Mass.) was used for data analysis. Herein the CF₂═CF—CF₂—O—CF₂—CF₂—CF₃ (MA-3) content, reported in units of weight %, was determined from an infrared band at 999 1/cm and was calculated as 1.24× the ratio (factor determined by means of solid-state NMR) of the 999 1/cm absorbance to the absorbance of the reference peak located at 2365 1/cm. The CF₂═CF—O—CF₂—CF₂—CF₃ (PPVE) content, reported in units of weight %, was determined from an infrared band at 993 1/cm and was calculated as 0.95×the ratio of the 993 1/cm absorbance to the absorbance of the reference peak located at 2365 1/cm. The CF₂═CF—O—(CF₂)₅—CN (MV5CN) content, reported in units weight %, was determined from an infrared band at 2236 1/cm and was calculated as the 2.62×the ratio of the 2236 1/cm absorbance to the absorbance of the reference peak located at 2365 1/cm.

### Melt-Flow Index

The melt-flow index (MFI), reported in g/10 min, was measured according to DIN EN ISO 1133-1:2012-03 at a support weight of either 2.16, 5.0, or 21.6 kg. The MFI was obtained with a standardized extrusion die of 2.1 mm diameter and a length of 8.0 mm. Unless otherwise noted, a temperature of 372° C. was applied.

### Differential Scanning Calorimetry (DSC)

The specimens were prepared for thermal analysis by weighing and loading the material into Mettler aluminum DSC sample pans. The specimens were analyzed using Mettler Toledo DSC 3+(Columbus, OH) utilizing a heat-cool-heat method in temperature modulated mode (−50 to 350° C. at 10° C./minute). After data collection, the thermal transitions were analyzed using the Mettler STARe Software version 16.00. If present, any glass transitions (Tg) or significant endothermic or exothermic peaks were evaluated based on the second heat flow curve. The glass transition temperatures were evaluated using the step change in the heat flow curve. The onset and midpoint (half height) of the transition were noted at the glass transition. Peak area values and/or peak minimum/maximum temperatures are also determined. Peak integration results are normalized for sample weight and reported in J/g.

The crystallinity (delta H) of a blend of crystallize fluoropolymers can be compared to the calculated crystallinity of it's individual components multiplied by the wt. % of each crystalline component to determine if the measured crystallinity of the blend is higher, lower, or about the same amount as the calculated crystallinity.

### Split Post Dielectric Resonator Measurement (at 24.7 GHz)

All split-post dielectric resonator measurements were performed in accordance with the standard IEC 61189-2-721 near a frequency of 25 GHz. Each thin material or film was inserted between two fixed dielectric resonators. The resonance frequency and quality factor of the posts are influenced by the presence of the specimen, and this enables the direct computation of complex permittivity (dielectric constant and dielectric loss). The geometry of the split dielectric resonator fixture used in our measurements was designed by the Company QWED in Warsaw Poland. This 25 GHz resonator operates with the TE_{01d} mode which has only an azimuthal electric field component so that the electric field remains continuous on the dielectric interfaces. The split post dielectric resonator measures the permittivity component in the plane of the specimen. Loop coupling (critically coupled) was used in each of these dielectric resonator measurements. This 25 GHz Split Post Resonator measurement system was combined with Keysight VNA (Vector Network Analyzer Model PNA 8364C 10 MHz-50 GHz). Computations were performed with the commercial analysis Split Post Resonator Software of QWED to provide a powerful measurement tool for the determination of complex electric permittivity of each specimen at 24.7 GHz.

### Core Shell Fluoropolymer Example 1

An oxygen-free 40 L-kettle was charged with 27 kg deionized water, 390 g of a 30 wt. % aqueous Emulsifier solution, 100 g PPVE and 200 mbar Ethane (at 25° C.). Then the reactor was heated to 75° C. and TFE was charged until a pressure of 10 bar was reached. The polymerization was initiated by feeding 3.0 g ammonium persulfate (APS) (dissolved in 50 g deionized water). TFE was constantly fed at 10 bar (1 MPa) pressure. After 5.6 kg total TFE, 280 g PPVE was fed into the reactor and additional 1 g APS was added. After 7.9 kg TFE, the polymerization was stopped. The latex had a solid content of 20.7 wt. % and a d50 of 122 nm. The coagulated, dried polymer had a PPVE content of 0.8 wt. % and a MFI (372° C., 5 kg) of 18 g/10 min. The Tm of the fluoropolymer was determined as described above. The polymer had a Tm of 323° C. and a recrystallization point at 306° C. The dry powder had a d50 of 470 μm.

### Core Shell Fluoropolymer Example 2

An oxygen-free 40 L-kettle was charged with 28 L of deionized water, 100 g of a 30 wt. % aqueous Emulsifier solution, 0.9 g of a 10 wt. % aqueous tert-butanol solution, 0.9 g of oxalic acid dihydrate and 82 g PPVE. The kettle was heated up to 40° C. and TFE was fed into the reactor to get 15 bar (1.5 MPa) pressure. The polymerization was initiated by adding 70 mg pure KMnO₄ (fed as 0.04 wt. % aq. solution), another 70 mg KMnO₄ was added continuously over the whole time (133 min). After 7.7 kg TFE was added, a mixture of 50 g MV5CN CF₂═CF—O—(CF₂)₅—CN, 1 g Emulsifier and 50 g water was fed to the polymerization. After a total of 8.3 kg TFE was fed into the reactor the polymerization was terminated. The latex had a solid content of 22.5 wt. %, d50 of 120 nm. The coagulated, dried polymer had an SSG of 2.146, PPVE content of 0.4 wt. %, and a nitrile-signal at 2236 cm-1 was visible. The Tm of the fluoropolymer was determined as described above, having a Tm of 328° C. and a recrystallization of 303° C. The dry powder had a d50 of 560 μm.

### Core Shell Fluoropolymer Example 3

An oxygen-free 40 L-kettle was charged with 28 kg of deionized water, 100 g of a 30 wt. % aqueous Emulsifier solution, 7 g of a 10 wt. % aqueous solution of tert-butanol, 0.9 g of oxalic acid dihydrate and 50 g of MA-3 (C₃F₇—O—CF₂—CF═CF₂ available from Anles, St. Petersburg, Russia). The kettle was heated up to 40° C. and TFE was added to reach 15 bar (1.5 MPa). The polymerization was initiated by feeding 76 mg KMnO₄ (as 0.04 wt. % aq. solution) to the reactor. During the whole runtime (160 min) another 40 mg KMnO₄ was added. A total of 8.3 kg of TFE was added. The final latex had a solid content of 22.5 wt. %, d50 of 110 nm. The coagulated, dried polymer had a SSG of 2.137 and an MA-3 content of 0.06 wt. %. The Tm of the fluoropolymer was determined as described above and has a Tm of 321° C. and a recrystallization point of 306° C. The dry powder had a d50 of 430 μm.

### Core Shell Fluoropolymer Example 4

A 40 Liter (L) kettle was charged with 28 L deionized water, 100 grams (g) of a 30 wt. % aqueous solution of ADONA [CF₃—O—(CF₂)₃—O—CFH—CF₂COO—NH₄+], 7 g of a 10 wt. % aqueous tert. butanol solution, 0.7 g oxalic acid, and 40 g PPVE (CF₂═CF—O—C₃F₇). The kettle was heated to 40° C. and TFE was fed into the reactor to get 15 bar pressure. Polymerization was initiated by adding 70 milligrams (mg) KMnO₄ (fed is 0.04 wt. % aqueous solution), another 70 mg KMnO₄ was added continuously over the runtime of 150 minutes. After 7.7 kilogram (kg) of TFE was added, a pre-emulsion of 20 g PPVE and 50 g CF₂═CF—O—(CF₂)₅CN and 1 g ADONA in 100 g water was fed. After a total of 8.5 kg TFE was fed into the reactor, the polymerization was terminated. The latex had a solid content of 23 wt. %, particle size d₅₀ 110 nanometers (nm). The standard specific gravity (SSG) was 2.142 g/cm³, PPVE-content 0.3 wt. %, MV5CN-content 0.006 wt. %. Melting point (heating rate 10 K/minute) of 335° C.

### Core Shell Fluoropolymer Example 5

EX-2 was prepared similarly to EX-1, except that 80 g PPVE was pre-charged and 8 kilograms (kg) TFE was added. The polymer showed a SSG of 2.146 g/cm³, PPVE-content 0.4 wt. %, melting point of 330° C.

### Core Shell Fluoropolymer Example 6

EX-3 was polymerized at 12.0 barr TFE pressure at 65° C. with APS (6 g). After 8.0 kg TFE feed, 100 g MV4S [CF₂═CF—O—(CF₂)₄SO₂F] were introduced as a pre-emulsion. After 9.2 kg TFE feed, the polymerization was terminated after 165 minutes. The latex had a solid content of 23 wt. %, d₅₀ of approximately 105 nm, and melting point of 332° C. MFI (372° C./21.6 kg)=0.02 g/10 minute.

Table 2: Adhesion peel strength between Cu substrate (Ra=3 microns) and comparative random perfluoropolymer films as also described in U.S. 63/184,444 filed May 5, 2021.

| | | | Cu Bonding/ | | |
|---|---|---|---|---|---|
| | | | Lamination | | |
| | Fluoropolymer | PPVE or PMVE, | (3 minutes) | Cu Peel | Df at 25 |
| EXAMPLE | Film | mol % (wt. %) | Temperature, ° C.* | force, N/cm | GHz |
| CE-1 | CFP-2 | PPVE, 1.5-2.0 mol % | 3M Cu/310° C. | 1.4 | 0.0004 |
| | | (4 wt. %) | | | |
| CE-2 | CFP-2 | PPVE, 1.5-2.0 mol % | 3M Cu/300° C. | 0.8 | 0.0004 |
| | | (4 wt. %) | | | |
| CE-3 | CFP-2 | PPVE, 1.5-2.0 mol % | 3M Cu/250° C. | no bonding | 0.0004 |
| | | (4 wt. %) | | | |
| CE-4 | CFP-1 | | 3M Cu/250° C. | 1.5 | 0.0004 |
| CE-5 | CFP-1 | | 3M Cu/266° C. | 4.2 | 0.0004 |
| CE-6 | CFP-1 | | 3M Cu/300° C. | 1.9 | 0.0004 |

### Skived Film Preparation of Examples 4-6

### Production of a Billet:

Type billet 45 mm preparation: 150 grams of core shell particles were filled into a billet form and pressed with 350 barr at a press speed of 50 mm/minute for 5 minutes at room temperature. The resulting billet was placed into an oven and heated from room temperature to 378° C. with a heating rate of 45° C./hour. This process ran for 8 hours. After reaching 378° C., the temperature was kept constant for 4 hours. After 4 hours, the billet was cooled to room temperature at a cooling rate of 45° C./hour for 8 hours.

### Skived Film Production:

The resulting billet was fixed into a lathe (Weiler GmbH (Gau-Algesheim, Germany), Type E70-1), at room temperature. The billet was turned at 23 revolutions per minute (rpm) and a feed speed of 0.05 mm/rotation. This resulted in a film thickness of 50 micrometers (μm). The film had a width of 45 mm.

### Bonding to Copper Test Method of Examples 4-6

Onto Kapton foil (1^{st} layer) was placed a layer of copper foil (2^{nd} layer). Onto the copper foil (2^{nd} layer) was placed a layer of skived fluoropolymer film (3^{rd} layer). And finally, onto the fluoropolymer film (3^{rd} layer) was placed a final layer of Kapton foil (4^{th} layer). The assembly of layers were heated to 360° C. and held at such temperature for 30 minutes at a pressure (controlled manually) of 54 barr using a press (Model LaboPress P200S (VOGT Labormaschinen GmbH, Berlin, Germany)) equipped with a vacuum pump (SOGEVAC SV25B from Leybold GmbH, Cologne, Germany). The sample was then cooled to 40° C. via active cooling and after the cool down, vacuum pressure was released.

Test specimens were cut to a length of 100 millimeters (mm) and a width of 15 mm. Two test specimens are bonded together (70 mm), with approx. 30 mm not bonded together on one end. These 30 mm are used to fix the specimen into the machine. The bonded specimen was placed into a universal testing machine used to test the tensile strength and compressive strength of materials (ZwickRoell Z010 (Ulm, Germany) with pneumatic fixes short. The peel speed was 150 mm/minute at 23° C. (samples are preconditioned for 16 hours at 23° C.).

TABLE 3
Adhesion peel strength between Cu substrate
and core shell perfluoropolymer films

| Fluoropolymer | Polymerized units with | Cu Peel force, |
|---|---|---|
| Film | Functional Groups(wt. %) | N/cm |
| Example 4 | 0.3 wt.% PPVE, | 16.2 |
| | 0.006 wt.% MV5CN | |
| Example 5 | 0.4 wt.% PPVE, | 14.8 |
| | 0.006 wt.% MV5CN | |
| Example 6 | 0.006 wt.% MV4S | 7.3 |

It is surmised that the composition of CFP-1 would also exhibit improved adhesion to (e.g. copper) metal when made as a core shell fluoropolymer with polymerized units of comonomer comprising a functional group (e.g. PPVE, MV5CN, and MV4S) concentrated in the shell.

TABLE 4
Dk/Df Measurements at 24.7 GHz

| | Thickness, | | | Tan |
|---|---|---|---|---|
| EXAMPLE | mm | Dk | Df | delta |
| Example 4 | 0.109 | 2.03 | 0.0007 | 0.00035 |
| Example 5 | 0.141 | 2.02 | 0.00084 | 0.00041 |
| Example 6 | 0.0634 | 2.00 | 0.00055 | 0.00027 |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. An electronic telecommunication article comprising a fluoropolymer layer comprising a core shell fluoropolymer comprising
at least 80, 85, 90, 95, 96, 97, 98, or 99 wt. % or greater of polymerized units of tetrafluoroethylene;
no greater than 1 wt. % of polymerized units of comonomer comprising a functional group selected from nitrile, halogen, sulfur oxide, perfluorinated alkyl ether, and carbonyl.

2. The electronic telecommunication article of claim 1 wherein core shell fluoropolymer comprises at least 0.3, 0.4, 0.5, 0.6, 0.7, or 0.8 wt-% of polymerized units comprising a perfluorinated alkyl ether.

3. The electronic telecommunication article of claim 1 wherein the core comprises a copolymer of TFE and at least one perfluorinated comonomer.

4. The electronic telecommunication article of claim 3 wherein the perfluorinated comonomer is an unsaturated perfluorinated alkyl ether.

5. The electronic telecommunication article of claim 1 wherein the comonomer has the general formula
R_{f}—O—(CF₂)ₙ—CF═CF₂
wherein n is 1 or 0 and Rf is a perfluoroalkyl or perfluoroether group.

6. The electronic communications article of claim 3 wherein the core shell fluoropolymer has a MFI (372 C with 2.16 kg) of less than 50 g/10 min.

7. The electronic telecommunication article of claim 1 wherein the core shell fluoropolymer comprises perfluorinated alkyl ether functional groups in combination with functional groups selected from nitrile, halogen, sulfur oxide or carbonyl.

8. The electronic telecommunication article of claim 1 wherein the core shell
fluoropolymer comprises nitrile functional groups, optionally in combination with functional groups selected from perfluorinated alkyl ether, halogen, sulfur oxide or carbonyl.

9. The electronic telecommunication article of claim 1 wherein the core shell
fluoropolymer comprises sulfur oxide functional groups, optionally in combination with functional groups selected from nitrile, halogen, perfluorinated alkyl ether, or carbonyl.

10. The electronic telecommunication article of claim 9 wherein the sulfur oxide groups are selected from —SO₂X¹, wherein X¹ is F or NH₂ or —SO₃X², wherein X² is H, Na, Li.

11. The electronic telecommunication article of claim 1 wherein the shell has a higher amount of functional groups than the core or the shell has a higher amount of functional groups than the average amount of functional groups of the core shell fluoropolymer.

12. The electronic telecommunication article of claim 1 wherein the fluoropolymer layer or core shell fluoropolymer layer has a higher adhesion to metal than a random fluoropolymer having the same composition.

13. The electronic telecommunication article of claim 1 wherein the core shell fluoropolymer layer exhibits a bond strength to copper of at least 5 N when heat laminated at a temperature no greater than 360° C. for 30 minutes at a pressure of 54 barr.

14. The electronic telecommunication article of claim 1 wherein the fluoropolymer further comprises up to 15 wt. % of polymerized units of HFP.

15. The electronic telecommunication article of claim 1 wherein the core shell fluoropolymer is semicrystalline having a melting point after a second heating of greater than 320° C.

16. The electronic telecommunication article of claim 1 wherein the core shell fluoropolymer is insoluble in fluorinated solvent selected from partially fluorinated ether, 3-ethoxy perfluorinated 2-methyl hexane, or 3-methoxy perfluorinated 4-methyl.

17. The electronic telecommunication article of claim 16 wherein the fluorinated solvent is a partially fluorinated ether, 3-ethoxy perfluorinated 2-methyl hexane, or 3-methoxy perfluorinated 4-methyl.

18. The electronic telecommunication article of claim 1 wherein the fluoropolymer has
i) a dielectric constant (Dk) of less than 2.75, 2.70, 2.65, 2.60, 2.55, 2.50, 2.45, 2.40, 2.35, 2.30, 2.25, 2.20, 2.15, 2.10, 2.05, 2.00, 1.95;
ii) a dielectric loss (Df) of less than 0.01, 0.009, 0.008, 0.007, 0.006, 0.005, 0.004, 0.003, 0.002, 0.001, 0.0009, 0.0008, 0.0007, 0.0006, 0.0005;
or a combination thereof.

19. The electronic telecommunication article of claim 1 wherein a substrate, patterned layer, insulating layer, passivation layer, cladding, protective layer, or a combination thereof comprises the core shell fluoropolymer.

20. The electronic telecommunication article of claim 1 wherein the article is an integrated circuit, printed circuit board, antenna, or optical cable.

21-37. (canceled)
